(19) United States
(12) Patent Application Publication
(10) Pub. No.: US 2026/0180100 A1
(43) Pub. Date: Jun. 25, 2026

(54) BATTERY PACK

(71) Applicant: TOYOTA BATTERY CO., LTD., Kosai-shi (JP)

(72) Inventor: Yuji KATAYAMA, Okazaki-shi (JP)

(21) Appl. No.: 19/429,929

(22) Filed: Dec. 22, 2025

(30) Foreign Application Priority Data
Dec. 23, 2024 (JP) 2024-226691

(51) Int. Cl. H01M 50/242; H01M 50/209; H01M 50/271; H01M 50/358; H01M 50/367

(52) U.S. Cl. CPC H01M 50/242; H01M 50/209; H01M 50/271; H01M 50/358; H01M 50/367; H01M 2200/20

(57) ABSTRACT

In a battery pack according to related art, it is difficult to easily replace a battery cell. A battery pack according to the present disclosure includes: a plurality of battery cells; a battery housing part configured to house the plurality of battery cells; and a plurality of vibration suppression plates each configured to apply a pressing force to the battery cells in a direction in which the battery cells are pressed against a bottom surface of the battery housing part, in which one of the vibration suppression plates is provided in at least one of the plurality of battery cells arranged in a row direction in which the plurality of battery cells are stacked, and all of the plurality of battery cells housed in the battery housing part are pressed by the plurality of vibration suppression plates.

### INCORPORATION BY REFERENCE

This application is based upon and claims the benefit of priority from Japanese patent application No. 2024-226691, filed on Dec. 23, 2024, the disclosure of which is incorporated herein in its entirety by reference for all purposes.

### BACKGROUND

The present disclosure relates to, for example, a battery pack in which a plurality of battery cells are housed.

A number of battery packs for housing a plurality of battery cells in a battery case have been proposed. Japanese Unexamined Patent Application Publication No. 2024-50379 discloses a technique related to heat dissipation of a battery pack housing a plurality of battery cells.

The battery pack disclosed in Japanese Unexamined Patent Application Publication No. 2024-50379 includes: a plurality of secondary batteries, each of which includes an external terminal on a bottom thereof; a bus bar assembly including a connection substrate for electrically connecting the external terminals of the respective secondary batteries and conducting heat from the external terminals; a case in which the bus bar assembly is disposed on the bottom and the plurality of the secondary batteries are connected to the bus bar assembly in an aligned state and housed; and a heat dissipation member which is disposed outside the case and dissipates heat from the connection substrate to the outside of the case. Further, Japanese Unexamined Patent Application Publication No. 2024-50379 discloses that the battery cells housed in the case are pressed by one vibration suppression plate.

### SUMMARY

However, if the battery pack housed in the case is pressed by one vibration suppression plate, the pressing forces for all the battery cells are lost in order to replace only some of the battery cells. Therefore, there is a problem that it is difficult to replace only some of the battery cells.

The present disclosure has been made in view of the above-described circumstances, and an object thereof is to provide a battery pack capable of facilitating the replacement of a battery cell.

An aspect of a battery pack according to the present disclosure is a battery pack including: a plurality of battery cells; a battery housing part configured to house the plurality of battery cells; and a plurality of vibration suppression plates each configured to apply a pressing force to the battery cells in a direction in which the battery cells are pressed against a bottom surface of the battery housing part, in which one of the vibration suppression plates is provided in at least one of the plurality of battery cells arranged in a row direction in which the plurality of battery cells are stacked, and all of the plurality of battery cells housed in the battery housing part are pressed by the plurality of vibration suppression plates.

By the battery pack according to the present disclosure, it is possible to provide a battery pack capable of facilitating the replacement of a battery cell.

The above and other objects, features and advantages of the present disclosure will become more fully understood from the detailed description given hereinbelow and the accompanying drawings.

### BRIEF DESCRIPTION OF DRAWINGS

FIG. 1 is a schematic diagram of a battery pack according to a first embodiment;

FIG. 2 is a cross-sectional view of the battery pack taken along a line II-II of FIG. 1;

FIG. 3 is a cross-sectional view for explaining a structure of a battery cell according to a second embodiment; and

FIG. 4 is a cross-sectional view for explaining a structure of a vibration suppression plate according to a third embodiment.

### DESCRIPTION OF EMBODIMENTS

For the clarification of the description, the following descriptions and the drawings are partially omitted and simplified as appropriate. Note that the same elements are denoted by the same reference numerals or symbols throughout the drawings, and redundant descriptions are omitted as necessary.

### First Embodiment

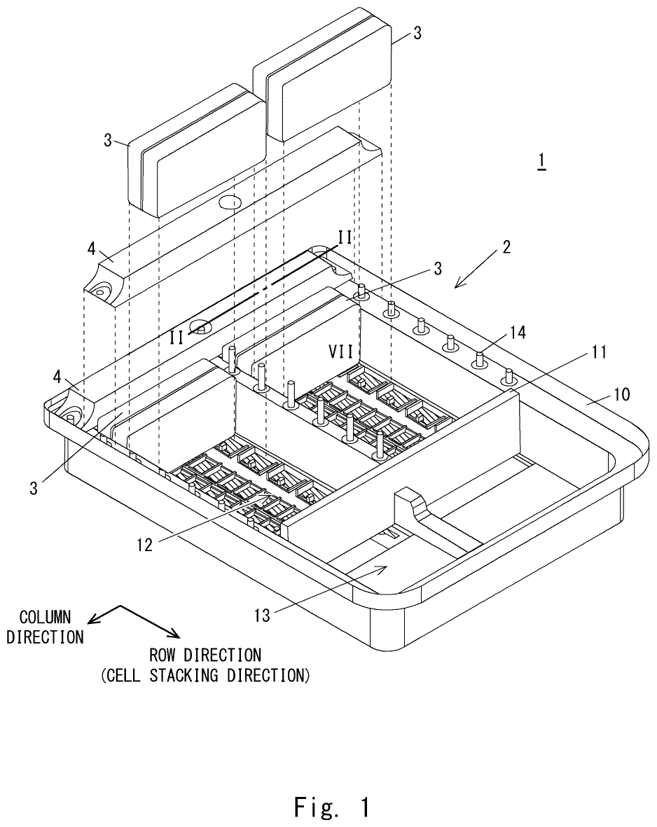

FIG. 1 is a schematic diagram of a battery pack 1 according to a first embodiment. As shown in FIG. 1, in the battery pack 1 according to the first embodiment, a plurality of battery cells 3 are housed in a lower case 2, and the housed battery cells 3 are pressed against a bottom surface of the lower case 2 by vibration suppression plates 4, so that the battery cells 3 are fixed in the lower case 2. FIG. 1 shows bolts 14 used for fixing the vibration suppression plates 4 to the lower case 2.

In FIG. 1, in order to explain a state in which the battery cells 3 are housed in the lower case 2, two of the battery cells 3 are housed in the lower case 2 as one set. However, the battery cells 3 housed in the lower case 2 are assembled in the shape of a battery stack in which one row of the battery cells 3 (14 of the battery cells 3 in the example shown in FIG. 1) are connected by bus bar components and then housed in the lower case 2 for each battery stack. Further, FIG. 1 shows an example in which two battery stacks are housed in two rows in one lower case 2. However, the number of rows of the battery stacks housed in the lower case 2 can be changed in accordance with the specifications of the battery pack 1 as appropriate. In the following description, the direction in which the battery cells 3 are stacked is referred to as a row direction, and the direction in which the battery stacks are arranged is referred to as a column direction, and the column direction is a direction orthogonal to the row direction.

The lower case 2 is composed of a lower case tab 10 formed by integrally molding a heat dissipation plate 20, which will be described later as an insert component, and resin. The heat dissipation plate 20 is disposed in the lower case tab 10 in such a way that a heat dissipation surface is exposed to the outside of a battery housing part 12. Further, the inside of the lower case tab 10 is separated into the battery housing part 12 and a junction box housing part 13 by providing a partition wall 11 in the lower case tab 10. A plurality of the battery cells 3 are housed in the battery housing part 12. Further, a junction box, which is a circuit for inputting and outputting electric power of the plurality of the battery cells 3, is disposed in the junction box housing part 13. In FIG. 1, the junction box itself is omitted. Further, in the lower case tab 10, a conductive component for connecting the above junction box to the plurality of the battery cells 3, a heat dissipation part for bringing the conductive component into contact with the heat dissipation plate 20, and the like can be formed. However, in FIG. 1, the conductive component disposed in the junction box housing part 13 and the heat dissipation part formed in the junction box housing part 13 are omitted.

Further, as shown in FIG. 1, a plurality of thermally conductive agent filling parts and a passage are formed in the bottom surface of the battery housing part 12. In each of the plurality of thermally conductive agent filling parts formed side by side in the row direction in which the battery cells 3 are stacked, a top surface of a heat dissipation projection formed on the rear side of the heat dissipation surface of the heat dissipation plate 20 is exposed, a pond structure part in which a plurality of walls are formed so as to surround an area where the top surface of the heat dissipation projection is exposed is formed at a position corresponding to an electrode component attached to the battery cell 3, and the pond structure part is filled with a thermally conductive agent. The passage is formed so as to extend in the row direction in an area adjacent to the plurality of thermally conductive agent filling parts.

Note that, as shown in FIG. 1, the battery pack 1 according to the first embodiment includes a plurality of the battery cells 3, the battery housing part 12 which houses the plurality of the battery cells 3, and a plurality of the vibration suppression plates 4 each of which applies a pressing force to the battery cells 3 in a direction in which the battery cells 3 are pressed against the bottom surface of the battery housing part 12. One of the vibration suppression plates 4 is provided in at least one of the plurality of the battery cells 3 arranged in the row direction. Further, in the battery pack 1 according to the first embodiment, all of the plurality of the battery cells 3 housed in the battery housing part 12 are pressed by the plurality of the vibration suppression plates 4. Further, each of the plurality of the battery cells 3 according to the first embodiment includes a smoke exhaust hole on the surface thereof facing the vibration suppression plate 4, the smoke exhaust hole discharging gas generated in a cell case that houses electrode bodies when the internal pressure of the cell case exceeds a preset internal pressure limit value. Further, each of the vibration suppression plates 4 includes a cylindrical smoke exhaust path including an opening that opens into the smoke exhaust hole in a part of a wall surface, the smoke exhaust path penetrating in the row direction in which the plurality of the battery cells 3 are stacked. The vibration suppression plate 4 will be described in detail below.

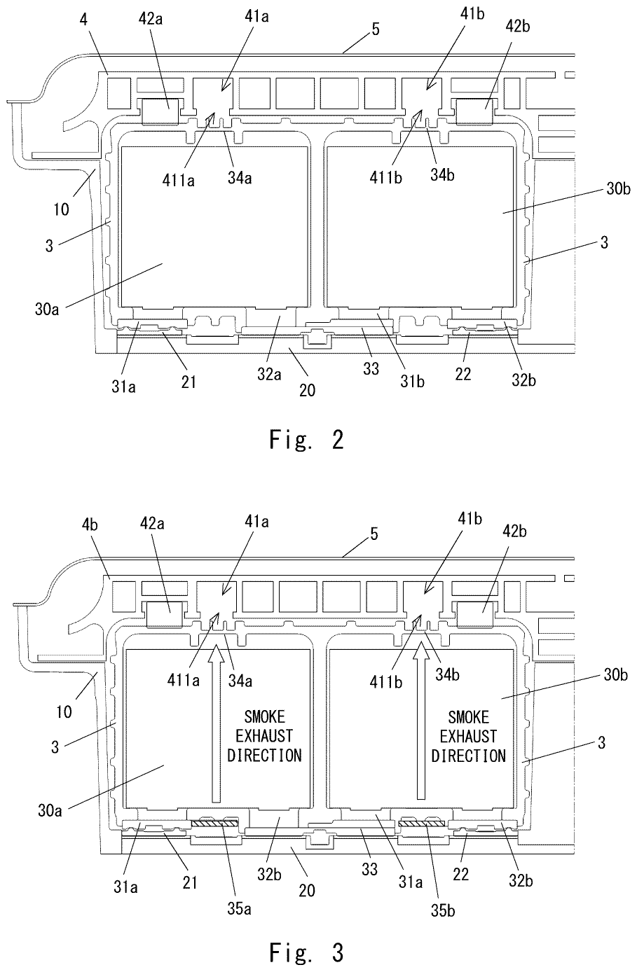

FIG. 2 is a cross-sectional view of the battery pack taken along a line II-II of FIG. 1. That is, FIG. 2 is a cross-sectional view for explaining a structure of the vibration suppression plate 4 according to the first embodiment. Note that FIG. 2 shows an upper lid 5 that is not shown in FIG. 1. The upper lid 5 covers the lower case 2 in such a way that it covers at least a plurality of the vibration suppression plates 4.

As shown in FIG. 2, in the lower case 2, the heat dissipation plate 20 is disposed so that a heat dissipation surface is exposed to the bottom surface, and a lower case tab 10, which is formed of resin so as to include the heat dissipation plate 20, is formed. Further, the battery cell 3 is fitted into the battery housing part 12 of the lower case 2. Note that FIG. 2 illustrates a cross-sectional structure of the battery pack 1 in an area including only one battery cell 3.

Further, the example shown in FIG. 2 shows the battery cell 3 having a structure in which two electrode bodies (e.g., electrode bodies 30a and 30b) are housed in the cell case. Note that the number of electrode bodies included in the battery cell 3 is not limited to a particular number. Further, although the above cell case is, for example, formed of resin so as to include metal components such as electrodes, the method for forming the cell case is not limited to a particular method.

The electrode body 30a includes a positive electrode terminal 31a and a negative electrode terminal 32a. The electrode body 30b includes a positive electrode terminal 31b and a negative electrode terminal 32b. In the battery cell 3, the negative electrode terminal 32a of the electrode body 30a is connected to the positive electrode terminal 31b of the electrode body 30b by an intermediate terminal 33. Further, in the battery cell 3, the cell case is configured so that at least the positive electrode terminal 31a of the electrode body 30a and the negative electrode terminal 32b of the electrode body 30b are exposed. Further, the battery cell 3 includes smoke exhaust holes 34a and 34b on the surface thereof facing the vibration suppression plate, the smoke exhaust holes 34a and 34b discharging gas generated in the cell case that houses the electrode bodies when the internal pressure of the cell case exceeds a preset internal pressure limit value. In the example shown in FIG. 2, the smoke exhaust hole 34a corresponds to the side of the electrode body 30a, and the smoke exhaust hole 34b corresponds to the side of the electrode body 30b. Further, in the battery pack 1 according to the first embodiment, a plurality of the battery cells 3 are connected in series by connecting the positive electrode terminal 31a and the negative electrode terminal 32b of the adjacent battery cells 3 by bus bar components 21 and 22. Further, in the battery pack 1 according to the first embodiment, a battery stack in which the plurality of the battery cells 3 are connected in series is housed in the battery housing part 12. In the battery pack 1 according to the first embodiment, by attaching the vibration suppression plate 4 to the battery stack housed in the battery housing part 12 in this way, each of the plurality of the battery cells 3 is fixed so as to be pressed against the bottom surface of the battery housing part 12. Note that the vibration suppression plate 4 is fixed to the lower case tab 10 by fastening parts such as bolts.

As shown in FIG. 2, the vibration suppression plate 4 includes cylindrical smoke exhaust paths including openings that open into the smoke exhaust holes in a part of the wall surface, the cylindrical smoke exhaust paths penetrating in the row direction in which a plurality of the battery cells 3 are stacked. FIG. 2 shows a smoke exhaust path 41a corresponding to the smoke exhaust hole 34a and a smoke exhaust path 41b corresponding to the smoke exhaust hole 34b. An opening 411a is provided in a part of the smoke exhaust path 41a that faces the smoke exhaust hole 34a, and an opening 411b is provided in a part of the smoke exhaust path 41b that faces the smoke exhaust holes 34b. Further, the vibration suppression plate 4 is provided so as to protrude toward the corresponding battery cell 3, and includes pressure members each of which transmits a pressing force to the battery cells. FIG. 2 shows a pressure member 42a which applies a pressing force to the cell case of the battery cells 3 on the side of the electrode body 30a, and a pressure member 42b which applies a pressing force to the cell case of the battery cells 3 on the side of the electrode body 30b. Each of the above pressure members is formed of, for example, an elastic member. Further, the contact pressure between the battery cell 3 and the bus bar component is maintained against the vibration applied to the battery pack 1 by the elastic force of the pressure member and the elastic force of the thermally conductive agent disposed between the bus bar component and the heat dissipation plate 20. That is, the pressure member 42a is optionally disposed on a vertical line of the positive electrode terminal 31a, and the pressure member 42b is optionally disposed on a vertical line of the negative electrode terminal 32b.

As described above, in the battery pack 1 according to the first embodiment, a plurality of the vibration suppression plates 4 are used as vibration suppression plates for pressing the battery cells 3 against the bottom of the lower case 2. Therefore, when some of the battery cells 3 are replaced, no influence is exerted on the battery cells 3 other than the battery cells 3 to be replaced, and thus high maintainability can be achieved.

Further, in the battery pack 1 according to the first embodiment, since the smoke exhaust paths 41a and 41b are provided in the vibration suppression plate 4, the smoke discharged from the smoke exhaust holes 34a and 34b of the battery cell 3 does not directly come into contact with the upper lid 5. Therefore, the upper lid 5 can be formed so as to be thin and the weight of the battery pack 1 can be reduced.

Further, in the battery pack 1 according to the first embodiment, since the smoke exhaust paths 41a and 41b are provided, the discharged smoke passes through limited paths. Therefore, the smoke can be discharged to the outside of the battery pack while reducing its influence on other battery cells 3.

### Second Embodiment

In a second embodiment, a battery cell 3a, which is a modified example of the battery cell 3, will be described. Note that, in the description of the second embodiment, the same components as those described in the first embodiment are denoted by the same reference numerals or symbols as those in the first embodiment, and the descriptions thereof are omitted.

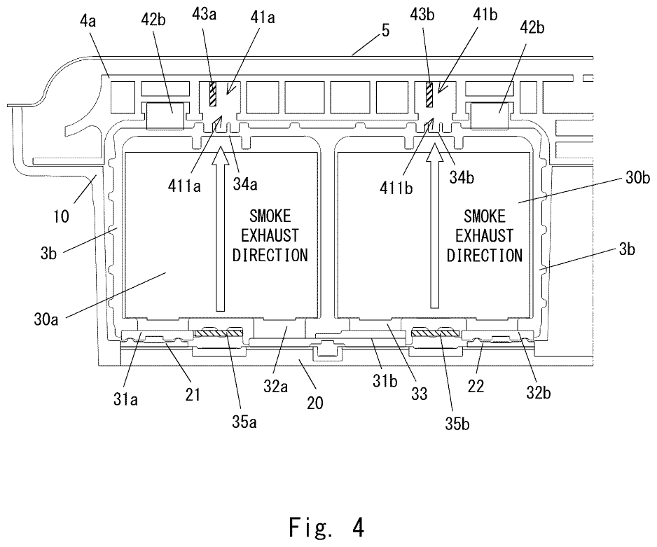

FIG. 3 is a cross-sectional view for explaining a structure of the battery cell 3a according to the second embodiment. As shown in FIG. 4, in the battery cell 3a according to the second embodiment, reinforcing members 35a and 35b each of which increases wall surface strength are provided on the walls that form the surfaces of the cell case facing the smoke exhaust holes 34a and 34b. Each of the above reinforcing members 35a and 35b may be provided on the front side of the wall surface of the case. However, for example, the cell case may be formed so that the length of a part of the positive electrode terminal 31a is increased and the extended part is embedded in the wall surface.

By providing the reinforcing members 35a and 35b in this way, it is possible to reliably discharge smoke from the smoke exhaust holes 34a and 34b.

### Third Embodiment

In a third embodiment, a vibration suppression plate 4a, which is a modified example of the vibration suppression plate 4, will be described. Note that, in the description of the third embodiment, the same components as those described in the first and the second embodiments are denoted by the same reference numerals or symbols as those in the first and the second embodiments, and the descriptions thereof are omitted.

FIG. 4 is a cross-sectional view for explaining a structure of the vibration suppression plate 4a according to the third embodiment. As shown in FIG. 4, the vibration suppression plate 4a according to the third embodiment includes projections 43a and 43b on the inner walls of the smoke exhaust paths 41a and 41b, respectively. In the example shown in FIG. 4, one projection is provided in each of the smoke exhaust paths. However, the number of projections provided in each of the smoke exhaust paths may be changed as appropriate. Further, the projections are integrally formed with other parts when the vibration suppression plate 4a is formed.

By providing the projections 43a and 43b, the area of the wall surfaces of the smoke exhaust paths 41a and 41b can be increased, and hence the temperature of discharged smoke can be reduced. That is, in the battery pack including the vibration suppression plate 4a according to the third embodiment, the temperature of smoke discharged to the outside of the battery pack can be reduced.

Note that the present disclosure is not limited to the above-described embodiments and may be changed as appropriate without departing from the scope and sprit of the present disclosure. Note that the present disclosure may be understood from the viewpoint of the following supplementary notes.

### (Supplementary Note 1)

A battery pack comprising:
a plurality of battery cells;
a battery housing part configured to house the plurality of battery cells; and
a vibration suppression plate configured to apply a pressing force to the battery cells in a direction in which the battery cells are pressed against a bottom surface of the battery housing part, wherein
each of the plurality of battery cells comprises a smoke exhaust hole on a surface thereof that faces the vibration suppression plate, the smoke exhaust hole being configured to discharge gas generated in a cell case that houses an electrode body when an internal pressure of the cell case exceeds a preset internal pressure limit value, and
the vibration suppression plate comprises a cylindrical smoke exhaust path including an opening that opens into the smoke exhaust hole in a part of a wall surface, the smoke exhaust path penetrating in a row direction in which the plurality of battery cells are stacked.

### (Supplementary Note 2)

The battery pack according to supplementary note 1, wherein
the vibration suppression plate is provided in at least one of the plurality of battery cells arranged in the row direction, and
all of the plurality of battery cells housed in the battery housing part are pressed by a plurality of the vibration suppression plates.

### (Supplementary Note 3)

The battery pack according to supplementary note 1, wherein the smoke exhaust path further includes a projection provided in an inner wall.

### (Supplementary Note 4)

The battery pack according to supplementary note 1, wherein each of the plurality of the vibration suppression plates is provided so as to protrude toward the corresponding battery cell, and further comprises a pressure member configured to transmit a pressing force to the battery cell.

### (Supplementary Note 5)

The battery pack according to supplementary note 1, wherein in each of the plurality of battery cells, a reinforcing member configured to increase wall surface strength is provided on a wall that forms a surface facing a surface where the smoke exhaust hole is provided.

### (Supplementary Note 6)

The battery pack according to supplementary note 5, wherein the reinforcing member is embedded in a wall.

### (Supplementary Note 7)

The battery pack according to supplementary note 1, further comprising a battery pack upper lid configured to cover the plurality of the vibration suppression plates.

The first to the third embodiments can be combined as desirable by one of ordinary skill in the art. From the disclosure thus described, it will be obvious that the embodiments of the disclosure may be varied in many ways.

Such variations are not to be regarded as a departure from the spirit and scope of the disclosure, and all such modifications as would be obvious to one skilled in the art are intended for inclusion within the scope of the following claims.

What is claimed is:

1. A battery pack comprising:
a plurality of battery cells;
a battery housing part configured to house the plurality of battery cells; and
a plurality of vibration suppression plates each configured to apply a pressing force to the battery cells in a direction in which the battery cells are pressed against a bottom surface of the battery housing part,
wherein one of the vibration suppression plates is provided in at least one of the plurality of battery cells arranged in a row direction in which the plurality of battery cells are stacked, and
wherein all of the plurality of battery cells housed in the battery housing part are pressed by the plurality of vibration suppression plates.

2. The battery pack according to claim 1, wherein:
each of the plurality of battery cells comprises a smoke exhaust hole on a surface thereof that faces the vibration suppression plate, the smoke exhaust hole being configured to discharge gas generated in a cell case that houses an electrode body when an internal pressure of the cell case exceeds a preset internal pressure limit value, and
each of the plurality of vibration suppression plates comprises a cylindrical smoke exhaust path including an opening that opens into the smoke exhaust hole in a part of a wall surface, the smoke exhaust path penetrating in the row direction in which the plurality of battery cells are stacked.

3. The battery pack according to claim 2, wherein the smoke exhaust path further includes a projection provided in an inner wall.

4. The battery pack according to claim 2, wherein each of the plurality of vibration suppression plates is provided so as to protrude toward the corresponding battery cell, and further comprises a pressure member configured to transmit a pressing force to the battery cell.

5. The battery pack according to claim 2, wherein in each of the plurality of battery cells, a reinforcing member configured to increase wall surface strength is provided on a wall that forms a surface facing a surface where the smoke exhaust hole is provided.

6. The battery pack according to claim 5, wherein the reinforcing member is embedded in the wall.

7. The battery pack according to claim 1, further comprising an upper lid configured to cover the plurality of vibration suppression plates.
